(19) United States
(12) Patent Application Publication
(10) Pub. No.: US 2009/0018962 A1
(43) Pub. Date: Jan. 15, 2009

(54) Method for activating application module

(75) Inventors: Hai-Hang Ying, Hangzhou City (CN); Jun-Ming Sheng, Hangzhou City (CN); Liang-Kui Feng, Fremont, CA (US)

Correspondence Address: BACON & THOMAS, PLLC, 625 SLATERS LANE, FOURTH FLOOR, ALEXANDRIA, VA, 22314-1176, US

(73) Assignee: ArcSoft, Inc., Fremont, CA (US)

(21) Appl. No.: 11/826,076

(22) Filed: Jul. 12, 2007

(51) Int. Cl. H04L 9/00

(52) U.S. Cl. 705/51

(57) ABSTRACT

A method for activating an application module is applied to an application program installed in an electronic device, wherein the application program includes at least more than one application module. When activating one of the application modules, the electronic device must firstly receive an activation code corresponding to the application module from a server of a program provider via the Internet, and the activation code is encrypted by the server of the program provider based on an activation information (such as a user name) and a module code corresponding to the application module, both of which are transmitted from the electronic device.

### FIELD OF THE INVENTION

The present invention relates to a method for activating an application module, and more particularly to a method for activating an application module applied to an application program of an electronic device.

### BACKGROUND OF THE INVENTION

Presently, Internet technologies are speedily developed, while the Internet is more and more available for users. Meanwhile, many design houses and manufacturers of application programs tend to design the application programs of which various operational procedures, such as a purchase procedure, a login procedure and an update procedure, can be directly carried out via the Internet. Furthermore, in order to satisfy the needs of different consumers, the design houses and the manufacturers thereof also tend to design several versions based on a common application program, such as to provide a trial version, a home version, a business version, and a professional version, all of which can be directly downloaded via the Internet and installed by the users after purchasing.

The foregoing network marketing mode of the application program is advantageous to efficiently prevent from wasting the resources of manufacturing material (such as optical disks) and packaging material, in order to substantially lower the manufacture cost and transportation cost. Meanwhile, the network marketing mode thereof provides a quicker purchase way with more convenience for users. Although the application programs of different versions can satisfy various needs of a portion of the users, the application programs still can not satisfy actual needs of most of the users. For example, the application program of home version has a lower price, but only provides a simpler function, so that the application program fails to attract the users' attention or to satisfy the users' actual needs after a period of use. Contrarily, the application program of professional version provides more functions, but has a higher price, while some of the functions are unnecessary and can not satisfy actual needs of the users resulting in a functional waste problem. Therefore, after the users purchase and use the application program over a period of time, the users may think that the application program can not satisfy actual needs thereof and decide to purchase a higher version. Alternatively, the users may think that the application program costs too much for providing too many unnecessary functions. Moreover, when the users purchase the application program via the Internet, it is generally needed to re-download a new purchased version and install it for updating the original application program. Such re-downloading procedure may occupy too much bandwidth of the Internet and waste too much time, resulting in an operational inconvenience to the users.

As a result, it is important for the design houses and the manufacturers of the application programs to design the application programs which need not be re-downloaded and installed and can be selectively started some specific functions therein according to actual needs of the users, wherein it generates additional fees only when the specific functions are started.

It is therefore tried by the inventor to develop a method for activating an application module to solve the problems existing in the conventional application programs of requiring re-downloading or re-installation. Also the application module can selectively activate some particular functions according to the users' need and permit the users to pay for those functions when the functions get activated.

### SUMMARY OF THE INVENTION

A primary object of the present invention is to provide a method for activating an application module applied to an application program installed in an electronic device, such as a notebook computer, a desktop computer, a personal digital assistant (PDA), or a mobile phone, wherein the application program comprises at least more than one application module; when activating one of the application modules, the electronic device must firstly receive an activation code corresponding to the application module from a server of a program provider via the Internet, and the activation code is encrypted by the server of the program provider based on an activation information (such as a user name) and a module code corresponding to the application module, both of which are transmitted from the electronic device.

A secondary object of the present invention is to provide a method for activating an application module, which has only one corresponding module code stored in a first hidden location in an electronic device when the application program is installed in the electronic device. The activation information (such as the user name) is inputted into the electronic device by the user and stored in a second hidden location in the electronic device. Thereby, when the electronic device is linked to the server of the program provider via the Internet for executing a paying operation and a licensing login operation, the electronic device transmits the module code and the activation information to the server, and then the server executes an encoding operation according to the module code and the activation information for generating the activation code which will be transmitted back to the electronic device. After the electronic device receives the activation code, the application program decrypts the activation code into a decrypted module code and a decrypted activation information, each of which will be respectively compared with the module code stored in the first hidden location and the activation information (such as the user name) stored in the second hidden location in the electronic device. If the decrypted module code and the decrypted activation information are respectively matched with the module code and the activation information, the corresponding application module will be started; and if no, the corresponding application module will still be in a non-functional status. As a result, the user can pay a relatively less fee to obtain an activation code via the Internet according to his/her actual needs, so as to start the corresponding application module of the application program. That is to say, each of the application modules of the application program can be respectively started. Furthermore, because the application modules originally exist in the application program, it is unnecessary for the user to re-download and install the application program or the application modules when the user purchases and starts the corresponding application module. Therefore, the method of the present invention not only can prevent from occupying the bandwidth of the Internet, but also saves the user's purchase expense, time, and manpower.

A third object of the present invention is to provide a method for activating an application module, wherein after the application module is started, the application program clearly displays a licensed activation information (such as the user name) on a certain location of a user interface displayed on the electronic device, so as to warn an illegal user of his/her illegally use of the application module.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a method for activating an application module according to a preferred embodiment of the present invention;

FIG. 2 is a processing flowchart of an application program when a user clicks an application module to start it according to the preferred embodiment of the present invention;

FIG. 3 is a processing flowchart of the application program when an electronic device starts the application module according to the preferred embodiment of the present invention;

FIG. 4 is an operational window of the application program displayed on the electronic device when the user clicks the application module to be started according to the preferred embodiment of the present invention;

FIG. 5 is an operational window downloaded from a server when the user executes a paying operation via the Internet for linking to the server of a program provider according to the preferred embodiment of the present invention;

FIG. 6 is an operational window for the user to select one of paying modes according to the preferred embodiment of the present invention; and

FIG. 7 is an operational window for displaying an inputted information of a credit card on the electronic device after the user selects to pay by a credit card according to the preferred embodiment of the present invention;

FIG. 8 is an operational window for displaying a billing information on the electronic device after the user inputs a correct information of the credit card according to the preferred embodiment of the present invention;

FIG. 9 is an operational window of the paying system, i.e. “PayPal Pro”, according to the preferred embodiment of the present invention;

FIG. 10 is an operational window for displaying information such as that relates to the purchased products on the electronic device after the user successfully logins into the paying system, e.g. “PayPal Pro”, with an account name according to the preferred embodiment of the present invention; and

FIG. 11 is an operational window for displaying a successful paying information on the electronic device through the paying system, e.g. “PayPal Pro”, according to the preferred embodiment of the present invention.

### DETAILED DESCRIPTION OF THE PREFERRED EMBODIMENTS

In the present invention, a plurality of functions provided by an application program are classified according to actual needs of general users, and further divided into a plurality of application modules based on degrees of difficulty, wherein each of the application modules has a function independent of yet related to that of the other application modules. For example, all of the application modules may be image processing programs, and one may be used to execute a deformation operation of image processing, while another may be used to execute a brightness adjustment of image processing. And the application modules can provide different functions, such as a low-level function, a middle-level function, a high-level function, and a professional function for satisfying the needs of different users. As a result, when the user initially uses the application program of the present invention, he/she can select a trial version thereof without paying any fee, so as to try a low-level application module only having fundamental functions. After the user tries the trial version over a period of time, he/she may need a high-level application module of the application program having some specific functions, so that the user can link to a server of a program provider of the application program via the Internet for paying a relatively less fee, in order to selectively purchase an activation code of the high-level application module. After finishing a paying operation and a licensing login operation, the user will obtain the activation code provided by the program provider, so as to start the high-level application module by the activation code for legally using the specific functions provided by the high-level application module.

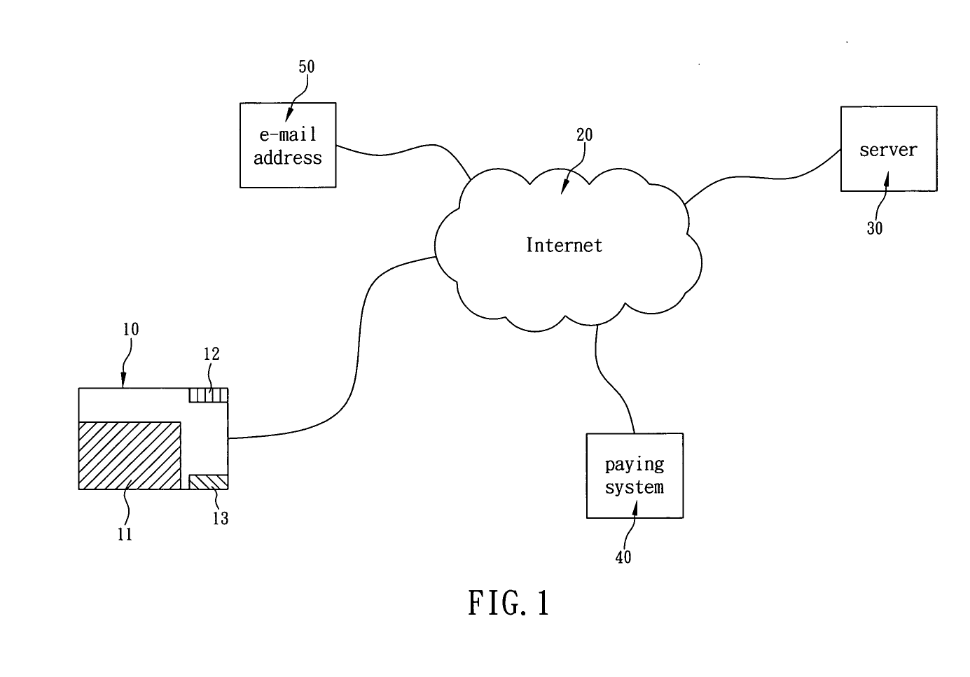

Referring now to FIG. 1, a method for activating an application module according to a preferred embodiment of the present invention is illustrated. As shown, the method is applied to an application program 11 installed in an electronic device 10, such as a notebook computer, a desktop computer, a personal digital assistant (PDA), or a mobile phone, wherein the application program 11 comprises at least more than one application module. When activating one of the application modules, the electronic device must firstly receive an activation code corresponding to the application module, and then start the application module by the activation code, so that the user will obtain a license to legally use specific functions provided by the application module. In the preferred embodiment of the present invention, the activation codes can be classified into two types as following:
1. A predetermined activation code: it is one or more than one activation code pre-set in the application program 11 in advance by the program provider. When the application program 11 is installed in the electronic device 10, the predetermined activation code is simultaneously written into a predetermined activation file stored in the electronic device 10, such as an activation file, e.g. “activate.dat”, stored in a root directory location of C:\Documents and Settings\ArcSoft\Product Name\. If necessary, the electronic device 10 can read out the activation code from the activation file for starting the corresponding application module. As a result, according to the foregoing method, the program provider can allow the user to directly start the different application module in the application programs of different versions, so that the user will be able to use different functions provided by one of the application modules; and
2. A purchased activation code: it is an activation code downloaded by the electronic device 10 which is linked to a server 30 of the program provider via the Internet 20 after the user finishes a paying operation and a licensing login operation, wherein the purchased activation code is written into another activation file stored in the electronic device 10, such as an activation file, e.g. “active.dat”, stored in a root directory location of C:\Documents and Settings\UserName\Application Data\ArcSoft\Product Name\. Therefore, when the user clicks one of the application modules, the electronic device 10 can read out the corresponding activation code from the activation file for starting the application module.

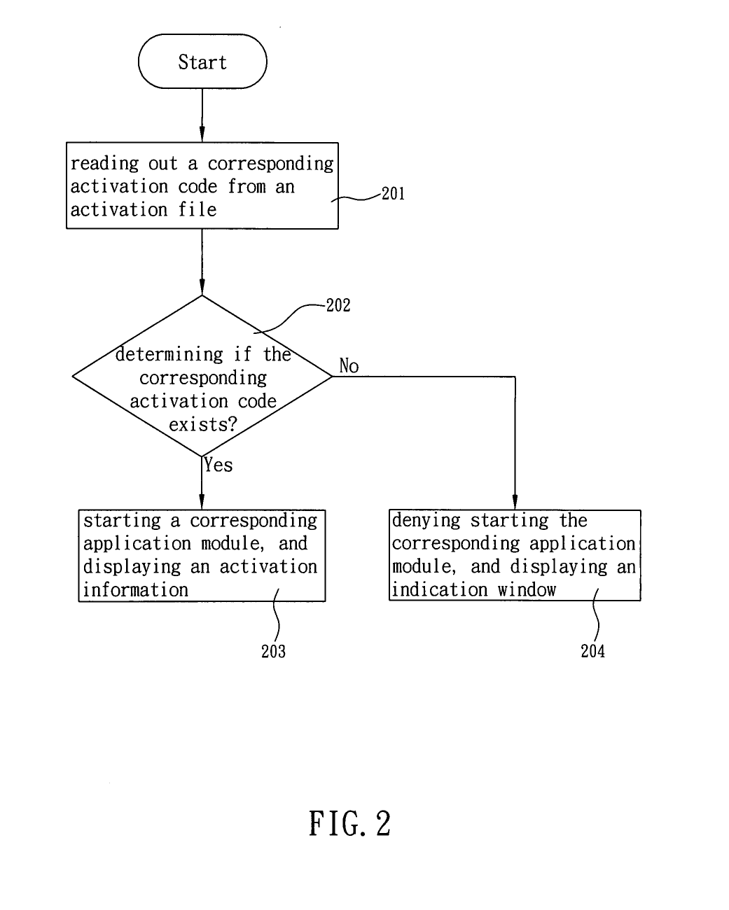

Referring now to FIG. 2, in the preferred embodiment of the present invention, when the user clicks one of the application modules for starting the application module, the application program 11 will execute the following steps:

In Step 201, reading out a corresponding activation code from an activation file according to a module code of the corresponding application module, wherein each of the application modules has only one corresponding module code;

In Step 202, determining if the corresponding activation code exists; if yes, going to Step 203; and if no, going to Step 204;

In Step 203, starting the corresponding application module, and clearly displaying an activation information on a certain location of a user interface displayed on the electronic device 10, wherein the activation information can be selected from an activation information (such as a user name, e.g. “Victor Wu”) inputted by the user when he/she finishes a paying operation and a licensing login operation, so that the user will be able to use functions provided by the corresponding application module; and

In Step 204, denying starting the corresponding application module, and displaying an indication window on the electronic device 10 for informing the user to pay via the Internet 20, in order to purchase the corresponding activation code for starting the corresponding application module.

In the preferred embodiment of the present invention, the activation code is encrypted from the module code and the activation information (such as a user name), wherein each of the application modules has only one corresponding module code which is stored in a first hidden location 12 in the electronic device 10 when the application program 11 is installed in the electronic device 10. When the activation code is written into an activation file, the application program 11 encrypts the activation file and records an encryption rule in an encryption file, such as an encryption file, e.g. “regdata.arg”, stored in a root directory location of C:\Program Files\Common Files\ArcSoft\connection Service\. Even if an illegal user copies the activation file, e.g. “activate.dat”, into another electronic device, he/she still can not obtain the encryption file “regdata.arg” due to the encryption file is a hidden file. As a result, the illegal user can not correctly decrypt the activation file to read out the activation code in the activation file for starting the corresponding application module.

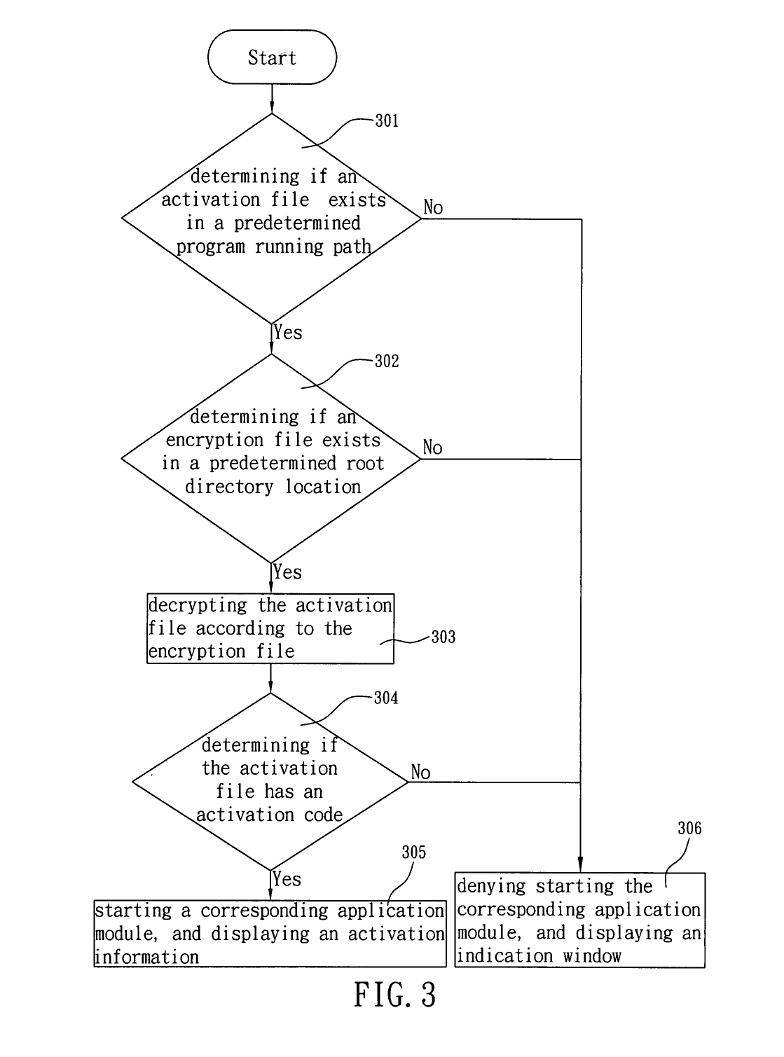

Referring back to FIG. 1, in the preferred embodiment of the present invention, when the electronic device 10 is linked to the server 30 of the program provider via the Internet 20 to execute the paying operation and the licensing login operation, the electronic device 10 will download an operational window from the server 30 to guide the user to select one of paying modes. For example, the user can select to pay through a paying system of a third party (such as a paying system 40, e.g. “PayPal Pro”). Alternatively, the user can select to pay via a credit card or directly pay by cash. After this, the operational window displayed on the electronic device 10 will guide the user to enter another operational window for inputting a user information. If the user correctly finishes inputting the user information, the electronic device 10 will display a billing information for the user to check. After this, the paying operation and the licensing login operation will be finished. Finally, the server 30 will send an e-mail including the billing information and the activation code to an e-mail address 50 of the user for the user to check and reserve. Meanwhile, the application program 11 will automatically activate the corresponding application module according to the activation code. It should be noted that the electronic device 10 will define some important information (such as a user name) in the user information as an activation information after the user correctly inputs the user information, and then store the activation information in a second hidden location 13 in the electronic device 10. Meanwhile, the electronic device 10 will send the module code and the activation information corresponding to the application module which will be started to the server 30, so that the server 30 will encrypt according to the module code and the activation information (such as the user name) after the user finishes the paying operation and the licensing login operation, so as to generate a corresponding activation code which will be transmitted back to the electronic device 10 and written into the activation file (such as “activate.dat”). Referring now to FIG. 3, when the electronic device 10 starts the application module, the application program 11 will execute the following steps:

In Step 301, determining if the activation file (such as “activate.dat”) exists in a predetermined program running path, i.e. determining if a predetermined root directory location (such as C:\Documents and Settings\ArcSoft\Product Name\) stores the desired activation file; if yes, going to Step 302; and if no, going to Step 306;

In Step 302, determining if the encryption file (such as “regdata.arg”) exists in a predetermined root directory location (such as C:\Program Files\Common Files\ArcSoft\connection Service\); if yes, going to Step 303; and if no, going to Step 306;

In Step 303, decrypting the activation file according to the encryption rule stored in the encryption file, and analyzing all activation codes stored in the activation file;

In Step 304, determining if the activation file has the activation code for starting the corresponding application module; if yes, going to Step 305; and if no, going to Step 306;

In Step 305, starting the corresponding application module, and clearly displaying an activation information (such as a user name) on a certain location of a user interface displayed on the electronic device 10, so that the user will be able to use functions provided by the corresponding application module; and

In Step 306, denying starting the corresponding application module, and displaying an indication window on the electronic device 10 for showing a fault message to the user, or informing the user to pay via the Internet 20 in order to purchase the corresponding activation code for starting the corresponding application module.

In the preferred embodiment of the present invention, when determining if the activation file has the activation code for starting the corresponding application module, it is necessary to decrypt the activation code into a decrypted module code and a decrypted activation information (such as the user name), each of which will be respectively compared with the module code stored in the first hidden location 12 in the electronic device 10 and the activation information (such as the user name) stored in the second hidden location 13 therein. If the decrypted module code and the decrypted activation information are respectively matched with the module code and the activation information, the corresponding application module will be started; and if no, the corresponding application module will still be in a non-functional status. As a result, the user can pay a relatively less fee to finish the paying operation and the licensing login operation for obtaining the activation code from the server 30 of the program provider via the Internet 20 according to his/her actual needs, so as to start the corresponding application module of the application program which has specific functions. That is, each of the application modules of the application program can be respectively started.

In the preferred embodiment of the present invention, it should be noted that the first hidden location 12 and the second hidden location 13 of the electronic device 10 can be selected from a storage location of a hard disk, a flash memory, or other equivalent storage elements, wherein the storage location is an unpublished private location assigned by the application program 11. Thus, the application program 11 can be designed in such a way that the electronic device 10 must be firstly linked to the server 30 of the program provider via the Internet 20 to execute a paying operation and a licensing login operation followed by inputting an activation information (such as a user name) according to an indication of an indication window, and then the application program 11 will store the activation information in the second hidden location 13 of the electronic device 10. As a result, if the user further uses the same electronic device 10 to link to the server 30 of the program provider via the Internet 20 to execute another licensing login operation for starting another application module, the electronic device 10 can directly read out the activation information (such as the user name) from the second hidden location 13 without further inputting the user name. After this, the activation information and the module code of the application module which will be started are commonly transmitted to the server 30, so that the server 30 encrypts according to the module code and the activation information to generate a corresponding activation code which will be transmitted back to the electronic device 10.

Furthermore, in the preferred embodiment of the present invention, for displaying a legal use status of the activation information (such as the user name) of each of the application modules, a certain location of a user interface displayed on the electronic device 10 will clearly display the activation information when the corresponding application module is started. As a result, because the user interface of the started application module always displays the activation information (such as the user name) with a legal license, it can be used to warn and remind an illegal user of his/her illegal using the application module and may facilitating stopping the illegal use.

Moreover, because the application modules originally exist in the application program, it is unnecessary for the user to re-download and install the application modules when the user purchases and starts the corresponding application module. Therefore, in addition to omitting the procedure of re-downloading and installing the application program or the application modules, the method of the present invention not only can prevent from occupying the bandwidth of the Internet, but also saves the user's purchase expense, time, and manpower.

Referring back to FIG. 1, in the preferred embodiment of the present invention, when the user uses the electronic device 10 to link to the server 30 of the program provider via the Internet 20 to execute a paying operation and a licensing login operation of a certain application module, the user may select one of two paying mechanisms as following:
1. Direct payment through a credit card: the user can use the electronic device 10 to link to an operational window provided by the server 30 of the program provider via the Internet 20 for inputting fundamental information of a credit card (such as a VISA card, a Master card, a Discover card, or an American Express card). After checking the fundamental information, the user can finish the paying operation; or
2. Payment through a paying system 40 of a third party (such as a paying system, e.g. “PayPal Pro”): the user can use the electronic device 10 to link to an operational window provided by the paying system 40 of the third party via the Internet 20 for inputting fundamental information. After checking the fundamental information, the user can finish the paying operation.

According to the method of the preferred embodiment of the present invention, during the user executes the paying operation via the Internet, the electronic device and the server of the program provider can interchange some information with each other, so as to carry out a function of automatically activating the corresponding application module. In other words, the operational procedure of the method of the present invention comprises a user end (i.e. the electronic device 10) and a server end (i.e. the program provider's server 30), wherein the user end is used to provide functions of collecting some information of the user, submitting an information list, automatically activating, etc., while the server end is used to provide functions of interchanging the information with the paying system, e.g. “PayPal Pro”, carrying out the paying operation via the Internet, interchanging the information of the user, etc.

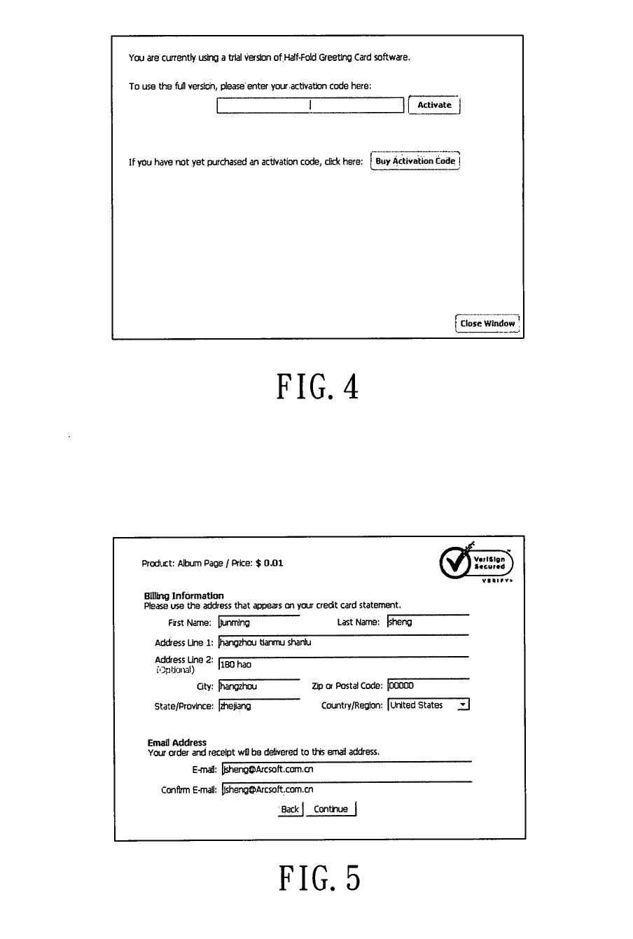

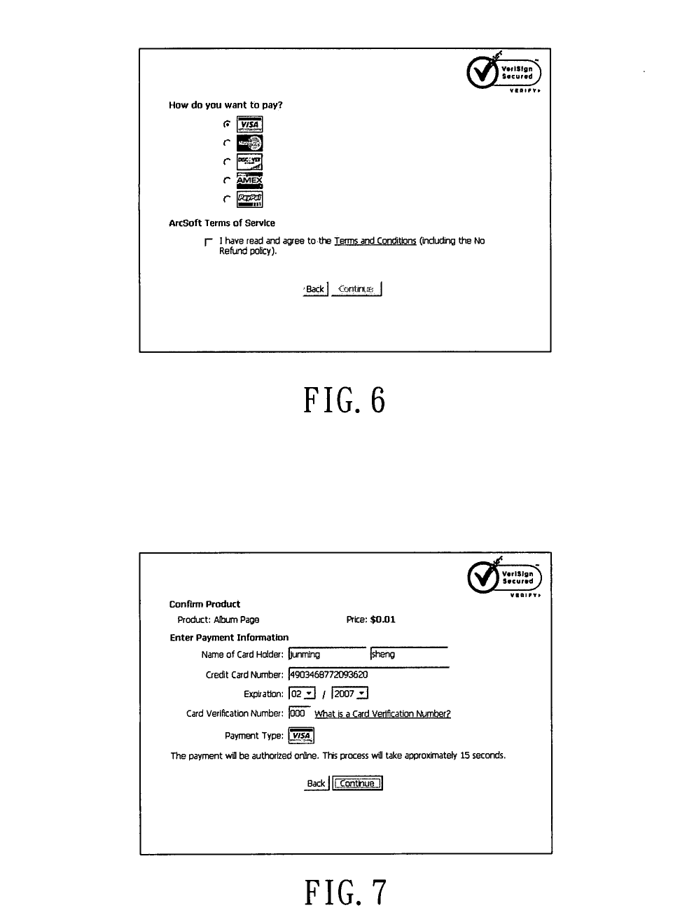

Furthermore, in the user end, the user must firstly click one application module which will be started, such as one application module of a card-making application program. Meanwhile, the application program 11 will display an operational window as shown in FIG. 4 on the electronic device 10. If the user already obtains an activation code, the user can input the activation code into an edition space, and then click an activate button for starting the application module. If the user doesn't obtain the activation code, the user can click a buy-activation-code button for entering a paying operation, wherein the electronic device 10 will be linked to the server 30 of the program provider via the Internet 20 for downloading an operational window as shown in FIG. 5 from the server 30 and displaying the operational window on the electronic device 10. The operational window comprises a safe connection information of SSL certification, and the user end can be link to a HTTPS between the server end and the user end through the operational window, so that the user end can request to obtain a product information via a control item of an Internet browser (such as Internet Explorer). When the user clicks a continue button, a next operational window as shown in FIG. 6 will be displayed for the user to select one of the paying modes.

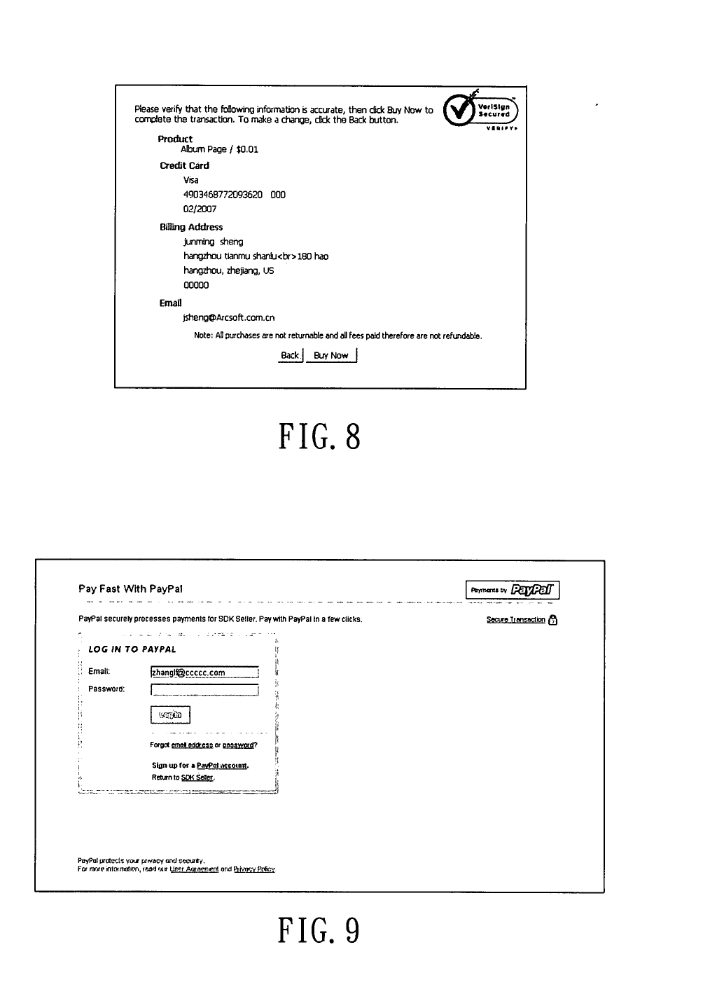

At this time, the user can select to pay through the paying system 40, “PayPal Pro”, of the third party or directly pay via a credit card. When the user selects to pay via the credit card, the operational window of the electronic device 10 will guide the user to enter into a next operational window as shown in FIG. 7 for inputting information of the credit card. After the user correctly inputs the information of the credit card, the electronic device 10 will display a next operational window as shown in FIG. 8 for displaying a billing information. If the user clicks a buy-now button, the paying operation will be finished. Meanwhile, the server end will provide information for the user to inform if the paying operation is successfully done. If yes, the server end will send an e-mail to the e-mail address 50 of the user for displaying the billing information and the activation code in responding to the successful payment. Meanwhile, the application program will automatically activate the corresponding application module according to the activation code. If the paying operation is not successfully done, the server end will send another operational window (not shown) for showing a fault message to the user and suggesting the user to re-input the correct information of the credit card.

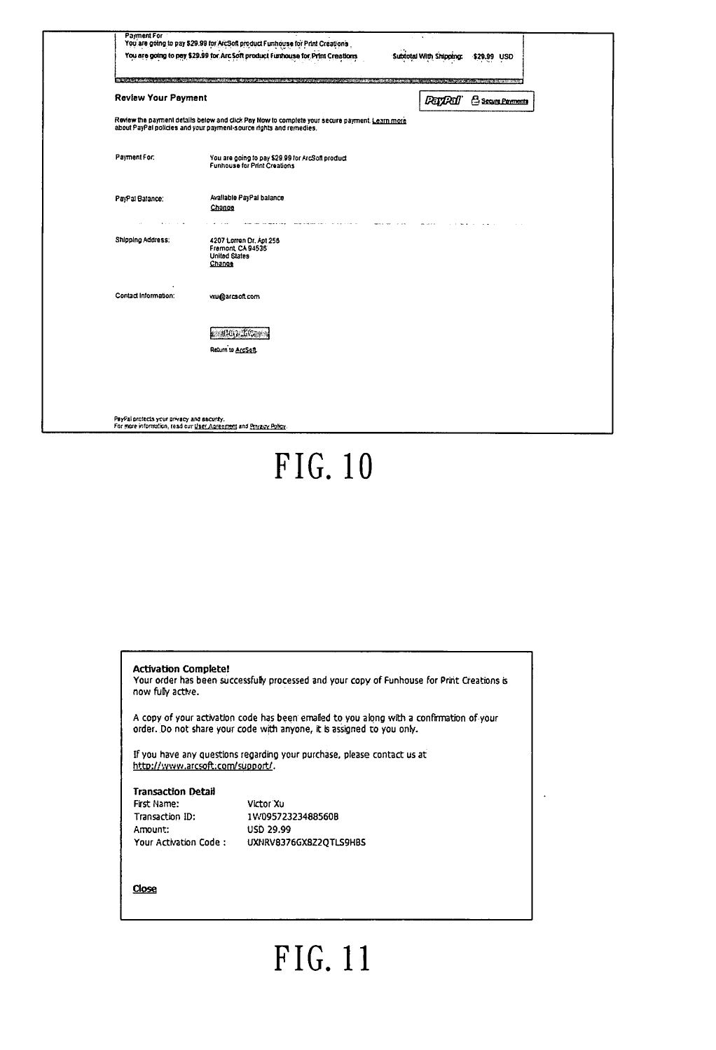

On the other hand, when the user selects to pay through the paying system 40 of the third party, e.g. “PayPal Pro”, the electronic device 10 will guide the user to enter into another operational window as shown in FIG. 9 to login into the paying system 40, e.g. “PayPal Pro”. After the user successfully logins into an account of the paying system 40, e.g. “PayPal Pro”, the electronic device 10 will display a next operational window as shown in FIG. 10 for displaying information relating to the purchased products. In the operational window as shown in FIG. 10, if the user clicks a buy-now button, the paying operation will be finished. Meanwhile, the electronic device 10 will display a next operational window as shown in FIG. 11 for displaying a successful paying information and showing a detail billing list of the paying operation. If the server 30 finds that the paying operation is not successfully done, electronic device 10 will display a fault message (such as “Can not fetch an activation code”) for informing the user to re-execute the paying operation.

In the preferred embodiment of the present invention, the server end preferably provides a plurality of active service pages (ASP) for successfully interchanging related information with the paying system 40, e.g. “PayPal Pro”, to carry out paying via the Internet and interchanging the information of the user. Moreover, the user interface used by the user end is preferably selected from a control item of an embedded Internet browser (such as Internet Explorer), while all of the active service pages (ASP) need a feedback of the server end.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for activating an application module applied to an electronic device which is installed with an application program, wherein the application program comprises at least more than one application module, each of which has only one corresponding module code stored in a first hidden location in the electronic device, while an activation information inputted by a user is stored in a second hidden location in the electronic device; and wherein each of the application modules has a corresponding activation code which is stored in an activation file stored in the electronic device, and the activation file is encrypted from the module code and the activation information so that when one of the application modules is clicked, the method executed by the electronic device comprises following steps:
reading out the activation code from the activation file;
decrypting the activation code into a decrypted module code and a decrypted activation information, each of which is respectively compared with the module code stored in the first hidden location in the electronic device and the activation information stored in the second hidden location therein; and
starting the corresponding application module when the decrypted module code and the decrypted activation information are respectively matched with the module code stored in the first hidden location in the electronic device and the activation information stored in the second hidden location therein;
otherwise, denying starting the corresponding application module.

2. The method for activating the application module of claim 1, wherein when the corresponding application module is started, the activation information is displayed on a location of a user interface of the application module.

3. The method for activating the application module of claim 1, wherein when the activation code is stored in the activation file, the electronic device encrypts the activation file and records an encryption rule in an encryption file in the electronic device.

4. The method for activating the application module of claim 2, wherein when the activation code is stored in the activation file, the electronic device encrypts the activation file and records an encryption rule in an encryption file in the electronic device.

5. The method for activating the application module of claim 3, wherein when decrypting the activation code, the electronic device decrypts the activation code stored in the activation file according to the encryption rule stored in the encryption file

6. The method for activating the application module of claim 4, wherein when decrypting the activation code, the electronic device decrypts the activation code stored in the activation file according to the encryption rule stored in the encryption file.

7. The method for activating the application module of claim 5, wherein the encryption file is a hidden file.

8. The method for activating the application module of claim 6, wherein the encryption file is a hidden file.

9. The method for activating the application module of claim 7, wherein the activation information is a user name.

10. The method for activating the application module of claim 8, wherein the activation information is a user name.

11. A method for activating an application module applied to an electronic device which is installed with an application program, wherein the application program comprises at least more than one application module, each of which has only one corresponding module code stored in a first hidden location in the electronic device when the application program is installed in the electronic device so that when one of the application modules is clicked, the method executed by the electronic device comprises the following steps:
linking to a server of a program provider via the Internet;
executing a paying operation and a licensing login operation, and then storing an activation information inputted by a user in a second hidden location in the electronic device;
transmitting the module code and the activation information to the server of the program provider;
receiving an activation code corresponding to the application module from the server of the program provider, wherein the activation code is encrypted from the module code and the activation information by the server of the program provider;
decrypting the activation code into a decrypted module code and a decrypted activation information, each of which is respectively compared with the module code stored in the first hidden location in the electronic device and the activation information stored in the second hidden location therein; and
starting the corresponding application module when the decrypted module code and the decrypted activation information are respectively matched with the module code stored in the first hidden location in the electronic device and the activation information stored in the second hidden location therein; otherwise, denying starting the corresponding application module.

12. The method for activating the application module of claim 11, wherein when the corresponding application module is started, the activation information is displayed on a location of a user interface of the application module.

13. The method for activating the application module of claim 11, wherein after receiving the activation code from the server of the program provider, the electronic device stores the activation code into an activation file in the electronic device in the electronic device.

14. The method for activating the application module of claim 12, wherein after receiving the activation code from the server of the program provider, the electronic device stores the activation code into an activation file in the electronic device in the electronic device.

15. The method for activating the application module of claim 13, wherein when the activation code is stored in the activation file, the electronic device encrypts the activation file and records an encryption rule in an encryption file.

16. The method for activating the application module of claim 14, wherein when the activation code is stored in the activation file, the electronic device encrypts the activation file and records an encryption rule in an encryption file.

17. The method for activating the application module of claim 15, wherein when decrypting the activation code, the electronic device decrypts the activation code stored in the activation file according to the encryption rule stored in the encryption file.

18. The method for activating the application module of claim 16, wherein when decrypting the activation code, the electronic device decrypts the activation code stored in the activation file according to the encryption rule stored in the encryption file.

19. The method for activating the application module of claim 17, wherein the encryption file is a hidden file.

20. The method for activating the application module of claim 18, wherein the encryption file is a hidden file.

21. The method for activating the application module of claim 19, wherein the activation information is a user name.

22. The method for activating the application module of claim 20, wherein the activation information is a user name.

23. A method for activating an application module applied to an electronic device which is installed with an application program, wherein the application program comprises at least more than one application module, each of which has only one corresponding module code stored in a first hidden location in the electronic device when the application program is installed in the electronic device, while an activation information inputted by a user is stored in a second hidden location in the electronic device so that when one of the application modules is clicked, the method executed by the electronic device comprises following steps:
transmitting the module code and the activation information to a server of a program provider;
receiving an activation code corresponding to the application module from the server of the program provider, wherein the activation code is encrypted from the module code and the activation information by the server of the program provider;
decrypting the activation code into a decrypted module code and a decrypted activation information, each of which is respectively compared with the module code stored in the first hidden location in the electronic device and the activation information stored in the second hidden location therein; and
starting the corresponding application module when the decrypted module code and the decrypted activation information are respectively matched with the module code stored in the first hidden location in the electronic device and the activation information stored in the second hidden location therein; otherwise, denying starting the corresponding application module.

24. The method for activating the application module of claim 23, wherein when the corresponding application module is started, displaying the activation information is displayed on a location of a user interface of the application module.

25. The method for activating the application module of claim 23, wherein after receiving the activation code from the server of the program provider, the electronic device stores the activation code into an activation file in the electronic device.

26. The method for activating the application module of claim 24, wherein after receiving the activation code from the server of the program provider, the electronic device stores the activation code into an activation file in the electronic device.

27. The method for activating the application module of claim 25, wherein when the activation code is stored in the activation file, the electronic device encrypts the activation file and records an encryption rule in an encryption file.

28. The method for activating the application module of claim 26, wherein when the activation code is stored in the activation file, the electronic device encrypts the activation file and records an encryption rule in an encryption file.

29. The method for activating the application module of claim 27, wherein when decrypting the activation code, the electronic device decrypts the activation code stored in the activation file according to the encryption rule stored in the encryption file.

30. The method for activating the application module of claim 28, wherein when decrypting the activation code, the electronic device decrypts the activation code stored in the activation file according to the encryption rule stored in the encryption file.

31. The method for activating the application module of claim 29, wherein the encryption file is a hidden file.

32. The method for activating the application module of claim 30, wherein the encryption file is a hidden file.

33. The method for activating the application module of claim 31, wherein the activation information is a user name.

34. The method for activating the application module of claim 32, wherein the activation information is a user name.

35. A method for activating an application module applied to an electronic device which is installed with an application program, wherein the application program comprises at least more than one application module, each of which has only one corresponding module code stored in a first hidden location in the electronic device, while a predetermined activation information is stored in a second hidden location in the electronic device so that when one of the application modules is clicked, the method executed by the electronic device comprises following steps:
reading out an activation code inputted by a user, and then storing the activation code in an activation file in the electronic device, wherein the activation code is encrypted from the module code and the activation information;
decrypting the activation code into a decrypted module code and a decrypted activation information, each of which is respectively compared with the module code stored in the first hidden location in the electronic device and the activation information stored in the second hidden location therein; and
starting the corresponding application module when the decrypted module code and the decrypted activation information are respectively matched with the module code stored in the first hidden location in the electronic device and the activation information stored in the second hidden location therein; otherwise, denying starting the corresponding application module.

36. The method for activating the application module of claim 33, wherein when the activation code is stored in the activation file, the electronic device encrypts the activation file and records an encryption rule in an encryption file.

37. The method for activating the application module of claim 34, wherein when the activation code is stored in the activation file, the electronic device encrypts the activation file and records an encryption rule in an encryption file.

38. The method for activating the application module of claim 35, wherein when the activation code is stored in the activation file, the electronic device encrypts the activation file and records an encryption rule in an encryption file.

39. The method for activating the application module of claim 36, wherein when decrypting the activation code, the electronic device decrypts the activation code stored in the activation file according to the encryption rule stored in the encryption file.

40. The method for activating the application module of claim 37, wherein when decrypting the activation code, the electronic device decrypts the activation code stored in the activation file according to the encryption rule stored in the encryption file.

41. The method for activating the application module of claim 38, wherein when decrypting the activation code, the electronic device decrypts the activation code stored in the activation file according to the encryption rule stored in the encryption file.

42. The method for activating the application module of claim 39, wherein the encryption file is a hidden file.

43. The method for activating the application module of claim 40, wherein the encryption file is a hidden file.

44. The method for activating the application module of claim 41, wherein the encryption file is a hidden file.
